(19) United States
(12) Patent Application Publication
(10) Pub. No.: US 2026/0044113 A1
(43) Pub. Date: Feb. 12, 2026

(54) FRICTION SYSTEM FOR A HOROLOGY MOVEMENT

(71) Applicant: BLANCPAIN SA, Le Brassus (CH)

(72) Inventors: Bernat MONFERRER, St-Prex (CH); Alain DELIZEE, Les Bioux (CH)

(73) Assignee: BLANCPAIN SA, Le Brassus (CH)

(21) Appl. No.: 19/247,327

(22) Filed: Jun. 24, 2025

(30) Foreign Application Priority Data
Aug. 6, 2024 (EP) 24193086.6

(51) Int. Cl. G04B 1/16; G04D 3/00

(52) U.S. Cl. CPC G04B 1/165; G04D 3/00

(57) ABSTRACT

A friction system (100) for a horology movement including: an arbor (1) with a longitudinal axis (L) including: a first fixed element (2) mounted so as to rotate integrally with the arbor (1) and having a first support surface (40); a second fixed element (7) mounted so as to rotate integrally with the arbor (1); a toothed organ (3) mounted so as to rotate freely on the arbor (1) between the first fixed element (2) and the second fixed element (7). The toothed organ (3) is integral with a socket coupling (4) having a second support surface (42), and the second fixed element (7) includes a body (72) configured to rotate integrally with the arbor (1) and resilient brackets (71) protruding relative to the body (72) and extending towards the toothed organ, the resilient brackets (71) being resiliently pressed against the second support surface (42) of the socket coupling.

### CROSS-REFERENCE TO RELATED APPLICATIONS

This application claims priority to European Patent Application No. 24193086.6 filed on Aug. 6, 2024, the entire contents of which are incorporated herein by reference.

### TECHNICAL FIELD OF THE INVENTION

The invention relates to the field of mechanical horology.

The invention relates more specifically to a friction system for a horology movement, for example for setting the time.

### TECHNOLOGICAL BACKGROUND

Friction systems are commonly used in horology movements. Friction systems allow a first organ to be made rotationally integral with a second organ until a torque limit value is reached. Once this limit is exceeded, the two organs are no longer rotationally integral. This type of system is generally used for hour and minute displays, particularly in cannon pinions for driving display hands or display discs.

The cannon pinion is usually indented to ensure friction between it and a pivot shank. Indenting consists of crimping a tube comprised in the cannon pinion opposite a shoulder or a pivot shank clearance. Crimping is a manual task, and its result depends on the dexterity and skill of the horologist, and is therefore unpredictable.

Correct adjustment of the friction torque is therefore challenging. Precise control of the clamping force applied is therefore important, and conventional manual indenting does not achieve this precision or the required reproducibility.

Another drawback is that frictions created by indenting cannot withstand the transmission of high torque and are sensitive to assembly and disassembly.

There are other solutions for obtaining friction, such as the use of metal foils as described in document FR 2394839, but manufacturing repeatability is difficult to guarantee from one batch to another.

Document CH 712197 describes another solution for creating friction which consists of using a spiral-shaped friction spring comprising an inner part that presses against a first annular support surface that is rotationally integral with a first toothed organ, and an outer part that presses against a second annular support surface that is integral with the second toothed organ, the inner part and the outer part being joined by at least one spiral-shaped resilient arm.

However, these solutions are complex to use, and their considerable footprint makes certain implementations in horology movements impossible.

### SUMMARY OF THE INVENTION

The present invention aims to remedy at least one of the aforementioned drawbacks.

The invention also aims to provide a friction system that enables the transmission of high torque, is easy to manufacture and offers easily manageable repeatability of the applied friction torque.

The invention also makes it possible to provide a friction system with a limited footprint, and in which the system's radial footprint is determined by the footprint of the toothed organs and not by the footprint of the friction system.

To this end, the present invention relates to a friction system for a horology movement comprising: an arbor, with a longitudinal axis L, designed to be mounted in the horology movement; a first fixed element mounted so as to rotate integrally with the arbor; said first fixed element having a first support surface; a second fixed element mounted so as to rotate integrally with the arbor; a toothed organ mounted so as to rotate freely on the arbor between the first fixed element and the second fixed element.

According to the invention, the toothed organ is integral with a socket coupling having a second support surface, and in that the second fixed element comprises a body configured to rotate integrally with the arbor, and resilient brackets protruding relative to the body and extending towards the toothed organ, said resilient brackets being resiliently pressed against said second support surface of the socket coupling, said resilient brackets being designed to distort resiliently under strain from the second support surface and to form a kinematic linkage both between the first fixed element and the toothed organ and between the second fixed element and the socket coupling integral with the toothed organ up to a predetermined friction torque.

The architecture of the friction system according to the invention makes it possible to use the entire length of the arbor while limiting the overall footprint of such a system in a radial direction. As a result, such a friction system is easier to fit into horology movements, and particularly into horology movements comprising numerous complications.

With this invention, the friction torque can be perfectly adjusted by axially controlling the driving in of the second fixed element on the arbor, the strain exerted by the resilient distortion of the resilient brackets on the socket coupling makes it possible to achieve a more gradual increase in friction torque, which facilitates precise and repeatable setting of a predetermined friction torque.

Moreover, such a friction system according to the invention is not sensitive to successive and repeated assembly/disassembly.

In addition to the characteristics mentioned in the previous paragraph, the friction system according to the invention can have one or more complementary characteristics from among the following, taken individually or in any technically possible combination:
the resilient brackets extend along an axis substantially parallel to the longitudinal axis of the arbor;
the second support surface is a conical support surface;
the second support surface is an internal support surface formed at the level of a hole reamed into the socket coupling and sloping towards the longitudinal axis of the arbor;
the second support surface is a conical external support surface formed on the periphery of the socket coupling and sloping outwards from the socket coupling;
the resilient brackets are resiliently pressed against said second support surface of the socket coupling at their free end;
the free end of the resilient brackets has a rounded or bevelled shape;
the first support surface of the first fixed element is flat or conical;
the socket coupling is made in one piece with the toothed organ;
the socket coupling is a separate part attached to the toothed organ;
the socket coupling is driven in on a tubular portion of the toothed organ.

The invention also relates to a horology movement comprising a friction system in accordance with the invention.

The invention also relates to a method for assembling a friction system according to the invention, the method comprising the following steps:
providing an arbor;
driving in a first fixed element on the axis in a predetermined axial position;
sliding a first toothed organ onto the axis as far as the first fixed element so that the first toothed organ is in contact with the first fixed element; the first toothed organ being integral with the socket coupling;
gradually driving in a second fixed element with resilient brackets directed towards the socket coupling on the arbor, so as to compress the resilient brackets against the socket coupling, to obtain a frictional kinematic linkage both between the first fixed element and the first toothed organ, and between the second fixed element and the socket coupling integral with the toothed organ until a predetermined friction torque is obtained.

### BRIEF DESCRIPTION OF THE FIGURES

Other features and advantages of the invention will become apparent from the following detailed description, given by way of non-limiting example, with reference to the attached drawings in which:

FIG. 1 shows a perspective view of a first exemplary embodiment of a friction system according to the invention;

FIG. 2 shows an exploded view of the friction system illustrated in FIG. 1;

FIG. 3 shows a longitudinal cross-sectional view along axis A-A of the first exemplary embodiment of the friction system shown in FIG. 1;

FIG. 4 is a detailed view showing in particular the friction-generating contact zone of the friction system illustrated in FIG. 1;

FIG. 5 is a detailed view showing the friction-generating contact zone of a variant embodiment of a friction system according to the invention;

FIG. 6 shows an exploded view of a second exemplary embodiment of a friction system according to the invention;

FIG. 7 shows a longitudinal cross-sectional view along axis A-A of the second exemplary embodiment of the friction system shown in FIG. 6;

FIG. 8 shows a longitudinal cross-sectional view along axis A-A of a third exemplary embodiment of the friction system according to the invention;

FIG. 9 is a schematic view of a timepiece comprising a horology movement fitted with a friction system according to the invention.

### DETAILED DESCRIPTION OF THE INVENTION

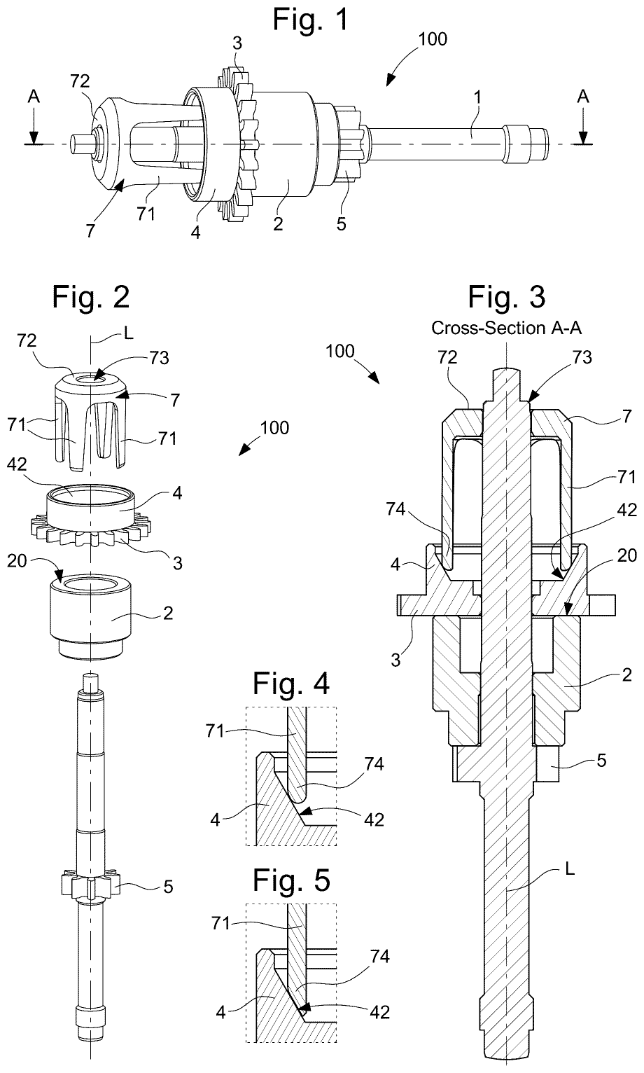

With reference to FIG. 1, a first exemplary embodiment of a friction system 100 according to the invention is shown. The system comprises an arbor 1 designed to be mounted in a horology movement 200; the arbor 1 extends along a central longitudinal axis L which forms the rotational axis of the arbor 1. The arbor 1 can comprise sections with different diameters and/or different shapes.

The arbor 1 carries a first toothed organ 3, for example a wheel, mounted so as to rotate freely on the arbor 1. Alternatively, this first toothed organ 3 can be a pinion or another element designed to be mounted with friction on the arbor 1.

The arbor 1 can also carry several toothed organs that are integral with the arbor 1, and can have a large number of known shapes according to the needs of the person skilled in the art.

The arbor 1 is, for example, a cannon pinion.

As shown in FIG. 1, the arbor 1 comprises a second fixed toothed organ 5 that is integral with the arbor 1. This second fixed toothed organ 5 can be a pinion, as shown, or a wheel. In the example shown, the second toothed organ 5 is made in one piece with the arbor 1. According to an alternative embodiment, this second toothed organ 5 can be driven in on the arbor 1 so as to be integral with the movements of the arbor 1.

As shown in FIG. 2, which illustrates an exploded view of the first exemplary embodiment of the friction system 100 according to the invention, the friction system 100 comprises a first fixed element 2, forming a first support element, such as an annular flange 2, driven in on the arbor 1 so as to be integral with the movements of the arbor 1.

This annular flange 2 has a first annular support surface 20 serving as a first friction surface between the annular flange 2 and the first toothed organ 3. The first toothed organ 3 rests on this annular support surface 20 via its bottom face.

The friction system 100 also comprises a second fixed element 7 driven in on the arbor 1. The first toothed organ 3 is mounted between the first fixed element 2 and the second fixed element 7. The axial position along the longitudinal axis L of the second fixed element 7 makes it possible to form a frictional kinematic linkage and to adjust the friction force of the friction system 100.

The friction system 100 also comprises a socket coupling 4, integral with the toothed organ 3, having a second support surface 42 cooperating with the second fixed element 7. This second support surface 42 is designed to receive and cooperate with the second fixed element 7 driven in on the arbor 1. The second support surface 42 therefore forms a second friction surface of the friction system 100 between the first toothed organ 3 and the second fixed element 7.

According to the exemplary embodiment shown in FIGS. 1 to 3, the socket coupling 4 is made in one piece with the first toothed organ 3. In this exemplary embodiment, the socket coupling 4 protrudes relative to the plate of the first toothed organ 3, opposite the lower face pressing on the annular support surface 20 of the annular flange 2.

For example, the socket coupling 4 is reamed with a conical hole with a conical inner surface that slopes towards the longitudinal axis L of the arbor 1. The conical inner surface of the socket coupling 4 forms the second support surface 42 of the friction system 100 according to the invention.

Other reaming profiles, not necessarily linear ones, are also possible without departing from the context of the invention insofar as the internal surface of the reaming hole has a profile that slopes towards the longitudinal axis L of the arbor 1. However, a conical profile with a linear slope is preferred.

The second fixed element 7 of the friction system 100 comprises a body 72 with a central orifice 73, and resilient brackets 71 that protrude relative to the body 72 on an outer peripheral region of the body 72. The resilient brackets 71 extend in a direction substantially parallel to the longitudinal axis L. The body 72 is mounted on the arbor 1 via the central orifice 73, preferentially by driving in.

The resilient brackets 71 have a free end 74 configured to press resiliently against the second support surface 42 of the socket coupling 4.

The free ends 74 of the resilient brackets 71 can have variable shapes, for example a rounded shape as shown in FIG. 4 or a bevelled shape as shown in FIG. 5. The bevelled shape advantageously increases the contact surfaces between the resilient brackets 71 and the second, preferentially conical, support surface 42 of the socket coupling 4, and therefore the friction torque of the friction system 100.

When the friction system 100 has been assembled, as illustrated in FIG. 3, the free ends 74 of the resilient brackets 71 are constrained by the geometry of the second support surface 42 and are more or less elastically distorted towards the inside of the system, meaning towards the axis L, depending on the axial position of the fixed element 7 relative to the first toothed organ 3. The elastic distortion by deflection, to a greater or lesser extent, of the resilient brackets 71 is proportional to the strain on the first toothed organ 3.

The friction torque of the friction system 100 according to the invention is thus generated depending on the position in which the second fixed element 7 is driven in on the arbor 1, to a greater or lesser extent, and therefore depending on the strain exerted by the resilient brackets 71 on the socket coupling 4.

With the invention, the friction torque can be perfectly adjusted by precisely driving the second fixed element 7 in on the arbor 1, the strain exerted by elastic distortion of the resilient brackets 71 on the socket coupling 4 making it possible to obtain a very precise friction torque, with progressive and controllable development of the friction torque as the second fixed element 7 is driven in. This makes it easier to precisely set the required friction torque depending on the position of the second fixed element 7 relative to the first toothed organ 3. In addition, the friction torque setting is repeatable because it is largely independent of the manufacturing tolerances of the various components of the friction system 100.

The strain exerted by the resilient brackets 71 can therefore be adjusted by acting on the relative separation between the second fixed element 7 and the first toothed organ 3, and more specifically between the second fixed element 7 and the second, preferentially conical, support surface 42 of the socket coupling 4 along the longitudinal axis L, which makes it possible to adjust the friction torque that the system can withstand before the first toothed organ 3 pivots relative to the arbor 1. Such a design makes setting extremely simple and easily reproducible.

Thus, when the parts assembly is mounted, the resilient brackets 71 of the second fixed element 7 form a kinematic linkage both between the first fixed element 2 and the first toothed organ 3, and between the second fixed element 7 and the toothed organ 3, via the socket coupling 4 up to a predetermined friction torque at the level of the toothed organ 3.

Preferably, the second fixed element 7 has at least three resilient brackets 71 so as to provide a better distribution of forces.

Preferably, as illustrated in FIGS. 1 to 3, the second fixed element 7 has four resilient brackets 71.

Preferentially, the resilient brackets 71 are distributed uniformly around the periphery of the body 72 with identical angular distances between each other to provide good distribution of the pressure force on the conical support surface 42 of the socket coupling 4.

In the exemplary embodiment shown in FIGS. 1 to 3, the four resilient brackets 71 are arranged 90° apart. If there is a greater number of resilient brackets, for example six, they would be arranged 60° apart.

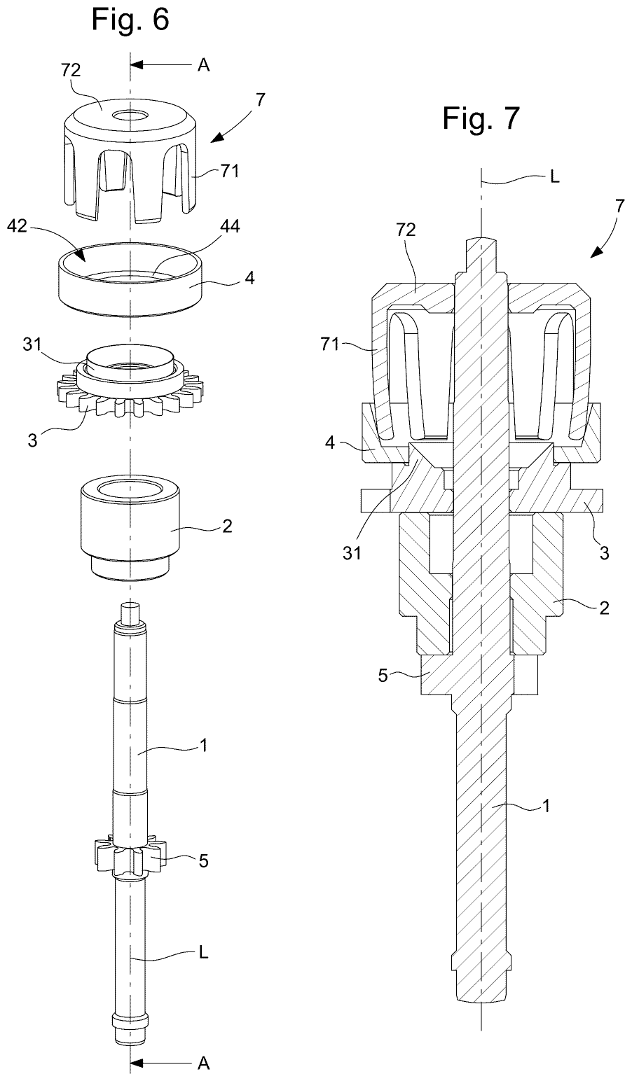

According to a second exemplary embodiment of the invention illustrated in FIGS. 6 to 7, the socket coupling 4 is a part attached to and driven in directly on the first toothed organ 3, so as to secure the socket coupling 4 to the toothed organ 3.

For example, the first toothed organ 3 comprises a male organ, for example a dimple, a post, a sleeve, a lug, etc., carried by the plate of the toothed organ 3, designed to cooperate with a female organ, for example a counterbore, a slot, a reaming hole, provided on the socket coupling 4.

Of course, the positions of the male organ and of the female organ can be reversed, such that the first toothed organ 3 comprises the female organ formed on its plate and the socket coupling 4 carries the male organ.

In the exemplary embodiment illustrated in FIGS. 6 and 7, the first toothed organ 3 comprises a tubular receiving portion 31, and the socket coupling 4 has a reaming hole 44 configured to cooperate by driving-in with the tubular receiving portion 31.

In particular, this second exemplary embodiment makes it possible to more freely dimension the diameter of the socket coupling 4 and therefore the extent of the second support surface 42, without the dimensioning constraints of the plate and of the toothing of the first toothed organ 3 associated with the operation of the horology movement 200.

This second exemplary embodiment makes it possible to increase the friction torque of such a friction system 100, in particular by increasing the diameter of the socket coupling 4 and of the second fixed element 7, which makes it possible to increase the number of resilient brackets 71 on the outer periphery of the body 72 in contact with the second support surface 42 to form the friction. This exemplary embodiment is therefore preferable when a high friction torque is required.

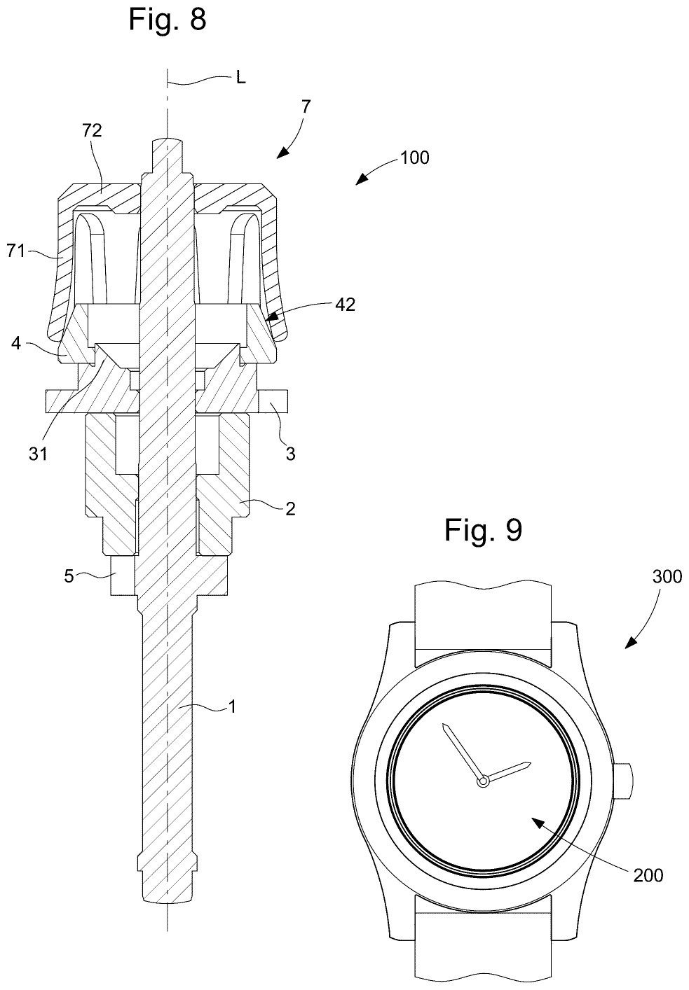

FIG. 8 illustrates a variant embodiment of the friction system 100 according to the invention. This variant embodiment is shown with the socket coupling 4 driven in on the first toothed organ 3; however, this variant embodiment is also applicable with a socket coupling 4 made in one piece with the first toothed organ 3 as previously described with reference to FIGS. 1 to 3.

In this variant embodiment, the socket coupling 4 has an external support surface formed on the periphery of the socket coupling 4 which forms the second support surface 42 of the friction system 100 according to the invention. The external support surface slopes outwards from the socket coupling 4.

Preferentially, the external support surface is a conical surface, but other profiles are possible without departing from the context of the invention.

Accordingly, in this embodiment, the resilient brackets 71 are elastically distorted towards the outside of the system 100, that is, away from the axis L relative to their neutral lock position, when the second fixed element 7 is driven in on the arbor 1 to a greater or lesser extent.

Such a variant facilitates lubrication of the support surface 42, which is a contact surface with the resilient brackets 71. Such a variant also makes it possible to obtain a multiplying effect of the friction torque as the second fixed element 7 is driven in, since the contact points between the resilient brackets 71 and the support surface 42 are radially increasingly distant from the centre of the arbor 1.

The friction system 100 according to the invention is, for example, a friction system for setting the time of a horology movement 200.

The invention also relates to a horology movement 200 comprising a friction system 100 in accordance with the invention, and to a timepiece 300 comprising such a horology movement 200.

The invention also relates to a method for assembling a friction system in accordance with the invention, the method comprising the following steps:
providing an arbor 1;
driving in a first fixed element 2 on the axis 1 in a predetermined axial position;
sliding a first toothed organ 3 onto the axis 1 as far as the first fixed element 2 so that the first toothed organ 3 is in contact with the first fixed element 2; the first toothed organ 3 being integral with the socket coupling 4;
gradually driving in a second fixed element 7 with resilient brackets 71 directed towards the socket coupling 4 on the arbor 1, so as to compress the resilient brackets 71 against the socket coupling 4, to obtain a frictional kinematic linkage both between the first fixed element 2 and the first toothed organ 3, and between the third fixed element 7 and the socket coupling 4 integral with the toothed organ 3 until a predetermined friction torque is obtained.

Of course, the present invention is not limited to the illustrated example and is open to various variants and modifications as will be apparent to the person skilled in the art, without departing from the scope of the invention as defined by the claims.

1. A friction system for a horology movement comprising:
an arbor with a longitudinal axis designed to be mounted in the horology movement;
a first fixed element, mounted so as to rotate integrally with the arbor; said first fixed element having a first support surface;
a second fixed element mounted so as to rotate integrally with the arbor;
a toothed organ, mounted so as to rotate freely on the arbor between the first fixed element and the second fixed element;
wherein the toothed organ is integral with a socket coupling having a second support surface, and in that the second fixed element comprises a body configured to rotate integrally with the arbor, and resilient brackets protruding relative to the body and extending towards the toothed organ, said resilient brackets being resiliently pressed against said second support surface of the socket coupling, said resilient brackets being designed to distort resiliently under strain from the second support surface and to form a kinematic linkage both between the first fixed element and the toothed organ and between the second fixed element and the socket coupling integral with the toothed organ up to a predetermined friction torque.

2. The friction system for a horology movement according to claim 1, wherein the resilient brackets extend along an axis that is substantially parallel to the longitudinal axis of the arbor.

3. The friction system for a horology movement according to claim 1, wherein the second support surface is a conical support surface.

4. The friction system for a horology movement according to claim 1, wherein the second support surface is an internal support surface formed at the level of a hole reamed into the socket coupling and sloping towards the longitudinal axis of the arbor.

5. The friction system for a horology movement according to claim 1, wherein the second support surface is an external support surface formed on the periphery of the socket coupling and sloping outwards from the socket coupling.

6. The friction system for a horology movement according to claim 1, wherein said resilient brackets are resiliently pressed against the said second support surface of the socket coupling at their free end.

7. The friction system for a horology movement according to claim 6, wherein the free end of the resilient brackets has a rounded or bevelled shape.

8. The friction system for a horology movement according to claim 1, wherein the first support surface of the first fixed element is flat or conical.

9. The friction system for a horology movement according to claim 1, wherein the socket coupling is made in one piece with the toothed organ.

10. The friction system for a horology movement according to claim 1, wherein the socket coupling is a separate part attached to the toothed organ.

11. The friction system for a horology movement according to claim 10, wherein the socket coupling is driven in on a tubular receiving portion of the toothed organ.

12. A horology movement comprising a friction system, said friction system comprising:
an arbor with a longitudinal axis designed to be mounted in the horology movement;
a first fixed element, mounted so as to rotate integrally with the arbor; said first fixed element having a first support surface;
a second fixed element mounted so as to rotate integrally with the arbor;
a toothed organ, mounted so as to rotate freely on the arbor between the first fixed element and the second fixed element;
wherein the toothed organ is integral with a socket coupling having a second support surface, and in that the second fixed element comprises a body configured to rotate integrally with the arbor, and resilient brackets protruding relative to the body and extending towards the toothed organ, said resilient brackets being resiliently pressed against said second support surface of the socket coupling, said resilient brackets being designed to distort resiliently under strain from the second support surface and to form a kinematic linkage both between the first fixed element and the toothed organ and between the second fixed element and the socket coupling integral with the toothed organ up to a predetermined friction torque.

13. A method for assembling a friction system according to claim 1, the method comprising the following steps:
providing an arbor;
driving in a first fixed element on the axis in a predetermined axial position;
sliding a first toothed organ onto the axis as far as the first fixed element so that the first toothed organ is in contact with the first fixed element; the first toothed organ being integral with a socket coupling;
gradually driving in a second fixed element with resilient brackets directed towards the socket coupling on the arbor, so as to compress the resilient brackets against the socket coupling, to obtain a frictional kinematic linkage both between the first fixed element and the first toothed organ, and between the second fixed element and the socket coupling integral with the toothed organ until a predetermined friction torque is obtained.
